(19) United States
(12) Patent Application Publication
(10) Pub. No.: US 2017/0209965 A1
(43) Pub. Date: Jul. 27, 2017

(54) Brass Compression Ring Removal Tool

(71) Applicant: Stewart Devereaux Lanier, Gilbert, AZ (US)

(72) Inventor: Stewart Devereaux Lanier, Gilbert, AZ (US)

(21) Appl. No.: 15/002,877

(22) Filed: Jan. 21, 2016

(51) Int. Cl. B23P 15/00; B25B 27/00

(52) U.S. Cl. CPC B23P 15/001; B25B 27/00

(57) ABSTRACT

The unique advantages of this tool are the small size of the tool, and the simplicity of the tool. It is composed of parts.

This tool is needed to provide all plumbers and do-it-yourselfers a better method of changing water shutoff valves wherever they are used, i.e. homes, hotels, businesses, restaurants, etc., cheaper and faster. The tool is extremely inexpensive. It can be used with one hand which makes it ideal for tight spaces.

### CROSS REFERENCE TO RELATED APPLICATIONS

Not Applicable

### REFERENCE TO SEQUENCE LISTING

Not Applicable

### RELATED APPLICATIONS

U.S. Pat. No. 6,637,089 Apr. 9, 2002 Compression Sleeve Puller

U.S. Pat. No. 6,904,660 Jun. 14, 2005 Compression Ring Puller

### BACKGROUND OF THE INVENTION

Brass pipes can be scarred when changing a water valve on toilets, etc. by forcing the brass compression ring off the water pipe, which results in water leaks. This invention removes the compression ring quickly without scarring or grooving the brass pipe. This results in faster repairs and greater customer satisfaction in time and materials.

### BRIEF SUMMARY OF THE INVENTION

This Tool provides an answer for all plumbers and Do-It-Your-Selfers to replace water valves using this very inexpensive Brass Compression Ring Removal Tool. Other tools cost four times the price of this tool and because of this; few repairmen have the proper tool in their bag. Should the brass pipe get scarred or damaged the replacement can be very costly to both repairmen and customer.

### DRAWINGS

FIG. 1 This is a drawing of the Compression Ring Removal Tool which has four parts, a handle, an aluminum frame, a threaded rod and a collar. The tool frame is 2 inches long and 1⅜ inches wide. The threaded rod is 5/16 by 2¼ inch and is made up of three parts, the handle, the threaded screw, and the screw collar. The collar is designed to fit inside the brass pipe, to center the pipe, as well as press against the edge of the pipe while the valve nut in being pulled off

FIG. 2 This drawing shows the Compression Ring Removal Tool claw placed in back of the valve nut.

FIG. 3 This drawing shows the centering piece inserted into the half-inch brass pipe.

FIG. 4 This drawing shows the claw pulling the valve nut and compression ring off the brass pipe

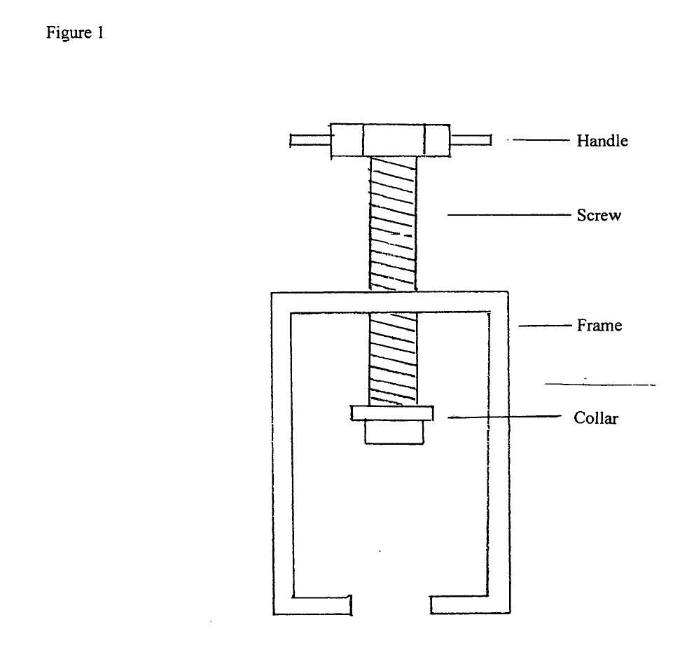

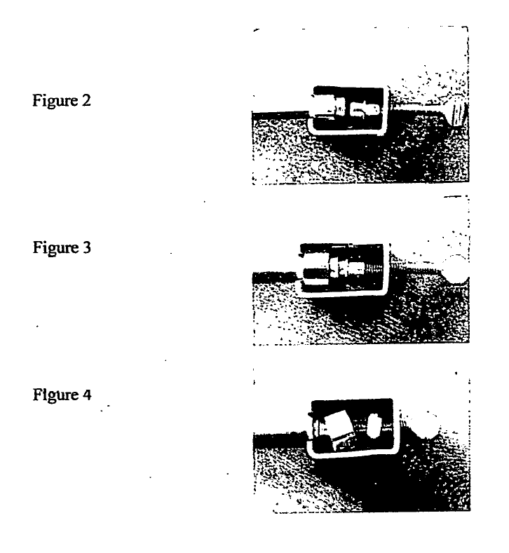

### DETAILED DESCRIPTION OF THE TOOL

The Tool removes the compression ring without damage to the brass pipe. Without this tool the brass ring is frequently removed with pliers, a Dremel tool, or hack saw, all of which can score the brass pipe resulting in water leaks. The Tool frame is aluminum, light weight, and easy to manufacture. The screw has a collar at the end that is designed to fit inside the brass pipe. Turning the screw “in” allows the collar to center itself inside the brass pipe while the raised shoulder contacts the edge of the pipe to hold it firmly. The “claw” part of the tool pulls the valve nut and brass compression ring off the brass pipe leaving the brass pipe undamaged.

The Brass Compression Ring Removal Tool will remove the brass compression ring from the brass water pipe quickly and effortlessly without any damage to the brass pipe.

1. The unique advantages of this tool are its small size and the simplicity of the tool.

2. The tool consists of two parts, the claw and the screw; therefore the tool is very light and can be used with one hand where space is limited.

3. The tool will not rust or become deformed.
